(19) United States
(12) Patent Application Publication
(10) Pub. No.: US 2024/0162678 A1
(43) Pub. Date: May 16, 2024

(54) COMPACT, HIGH POWER MID-WAVE INFRARED (MWIR) LASER SYSTEM

(71) Applicant: APPLIED ENERGETICS, INC., TUCSON, AZ (US)

(72) Inventors: Alan Kost, Tucson, AZ (US); Stephen William McCahon, Tucson, AZ (US)

(73) Assignee: APPLIED ENERGETICS, INC., TUCSON, AZ (US)

(21) Appl. No.: 18/296,143

(22) Filed: Apr. 5, 2023

Related U.S. Application Data
(60) Provisional application No. 63/362,478, filed on Apr. 5, 2022.

(51) Int. Cl. H01S 3/30; H01S 3/067; H01S 3/08; H01S 3/16; H01S 3/23

(52) U.S. Cl. CPC H01S 3/305; H01S 3/08013; H01S 3/08054; H01S 3/1616; H01S 3/1618; H01S 3/2316; H01S 3/0675; H01S 2302/00

(57) ABSTRACT

Mid-Wave Infrared (MWIR) laser systems emits at multiple wavelengths spanning the mid-IR transmission bands with tunability not to coincide with absorption lines within the bands. Optical fiber-based pump sources and a series of Raman fiber wavelength shifting amplifiers create a single output aperture that contains multiple spectral lines within each MWIR sub-band.

### CROSS-REFERENCE TO RELATED APPLICATIONS

The present application relates to and claims the benefit of priority to U.S. Provisional Patent Application Ser. No. 63/362,478, filed Apr. 5, 2022, which is hereby incorporated by reference in its entirety for all purposes as if fully set forth herein.

### BACKGROUND OF THE INVENTION

### Field of the Invention

Embodiments of the present invention relate, in general, to Mid-Wave Infrared (MWIR) laser systems and more particularly to a MWIR laser system having a single output aperture containing multiple spectral lines within each sub-band.

### Relevant Background

Infrared imaging systems trace their origins to the year 1800 when John Frederik William Herschel's experiments on refraction of invisible rays using a prism and a monochromator discovered infrared radiation, which Herschel called “calorific rays.”

The development of modern infrared detectors became possible after John Bardeen and William Shockley invented the transistor in 1947. Thereafter, InSb, HgCdTe, and Si photon detectors were developed. Texas Instruments developed the first forward-looking infrared system in 1963, with production in 1966, and in 1969, the charge-coupled device (CCD) was developed by AT&T Bell Labs. Photon infrared technology combined with molecular beam epitaxy and photolithographic processes revolutionized the semiconductor industry, thus enabling the design and fabrication of complex focal plane arrays.

One application of infrared technology is infrared counter measures. An infrared countermeasure (IRCM) is a device designed to protect aircraft from infrared homing (“heat seeking”) missiles and the like by confusing the devices' infrared guidance system so that they miss their target (electronic countermeasure). Heat-seeking missiles were responsible for about 80% of air losses in Operation Desert Storm. The most common method of infrared countermeasure is deploying flares, as the heat produced by the flares creates hundreds of targets for the missile. Flares create infrared targets with a much stronger signature than the aircraft's engines providing false targets that cause the missile to make incorrect steering decisions, but flares are not entirely effective. An aircraft carries a fixed number of flares and once they are depleted do too is the aircraft's IRCM. Countermeasure systems are usually integrated into the aircraft, such as in the fuselage, wing, or nose of the aircraft, or fixed to an outer portion of the aircraft. Depending on where the systems are mounted, they can increase drag, reducing flight performance and increasing operating cost. Much time and money are spent on testing, maintaining, servicing, and upgrading systems. These procedures require that the aircraft are grounded for a period of time.

Directional Infrared Countermeasures, avoid this potential drawback by mounting the energy source on a movable turret (much like a FLIR turret). They only operate when cued by a missile warning system of a missile launch and use the missile plume to accurately aim at the missile seeker. The modulated signal can then be directed at the seeker, and the modulation scheme can be cycled to try to defeat a variety of seekers. Countermeasure success depends on a threat's tracking techniques and requires a proper analysis of the missile's capabilities. Defeating advanced tracking systems requires a higher level of DIRCM power. Unfortunately, such systems typically involve high-power laser sources (100-Watts or greater) that are “tunable” across the bands requiring complex and expensive tuning elements.

A need exists for a simple, cost effective IRCM system that operates at multiple wavelengths in the mid-infrared (mid-IR) atmospheric transmission bands of 3.5-4.1 μn and 4.6-4.9 μm. Such an approach would use laser systems that emit signals at a plurality of wavelengths that span the mid-IR transmission bands—ideally with enough tunability such that the emitted signals do not coincide with absorption lines within the bands yet be simpler and cost effective. Currently, a cascaded Raman amplifier is used passing a pump laser beam through a series of Raman media that are sequentially tuned to different Raman shifts. Each Raman medium amplifies the Stokes beam produced by the previous medium, resulting in a cascade of Raman shifts that converts the pump laser power into multiple mid-1R lines.

Another approach of the prior art involves coupling the pump laser beam into a resonant cavity containing a Raman medium. The Raman medium amplifies the Stokes beam produced by the pump laser, resulting in a laser emission at a longer wavelength. By using a plurality of Raman mediums to tune different Raman shifts, it is possible to generate multiple corresponding mid-1R laser lines from a single pump laser.

Lacking is a system that generates a plurality of mid-IR laser lines using vibrational and rotational Raman amplification. These and other deficiencies of the prior art are addressed by one or more embodiments of the present invention.

Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### BRIEF DESCRIPTION OF THE DRAWINGS

Features and objects of the present invention and the manner of attaining them will become more apparent, and the invention itself will be best understood, by reference to the following description of one or more embodiments taken in conjunction with the accompanying drawings and figures imbedded in the text below and attached following this description.

FIG. 1 presents a basic architectural unit to product multiple infrared laser lines according to one embodiment of the present invention.

FIG. 2 illustrates the location of Stokes-shifted laser lines for selected transitions in various Raman active media resulting from one embodiment of the present invention.

FIG. 3 presents another implementation of the Raman shifting architecture to produce laser lines in the lower mid-infrared band according to the present invention.

FIG. 4 is a spectrum for a laser source for the lower mid-infrared band presenting a full output spectrum and the spectral shift for a change in pump wavelength of 3-nm.

FIG. 5 is another implementation of a Raman shifting architecture to produce laser lines in the lower mid-infrared band according to one embodiment of the present invention.

FIG. 6 illustrates the spectrum for laser source for the upper mid-infrared band resulting from the implementation shown in FIG. 5.

FIG. 7 is a flowchart illustrating one method embodiment for forming Mid-Wave Infrared (MWIR) optical lines according to the present invention.

The Figures depict embodiments of the present invention for purposes of illustration only. Like numbers refer to like elements throughout. In the figures, the sizes of certain lines, layers, components, elements, or features may be exaggerated for clarity. One skilled in the art will readily recognize from the following discussion that alternative embodiments of the structures and methods illustrated herein may be employed without departing from the principles of the invention described herein.

### DESCRIPTION OF THE INVENTION

A MWIR laser systems emits at multiple wavelengths spanning the mid-IR transmission bands with tunability to not coincide with absorption lines within the bands. The present invention uses optical fiber-based pump sources and a series of Raman fiber wavelength shifting amplifiers to create a single output aperture that contains multiple spectral lines within each required MWIR sub-band.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings but are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The terminology used herein is for the purpose of describing embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present), and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with, or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under”, or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

Included in the description are flowcharts depicting examples of the methodology which may be used form Mid-Wave Infrared (MWIR) optical lines. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

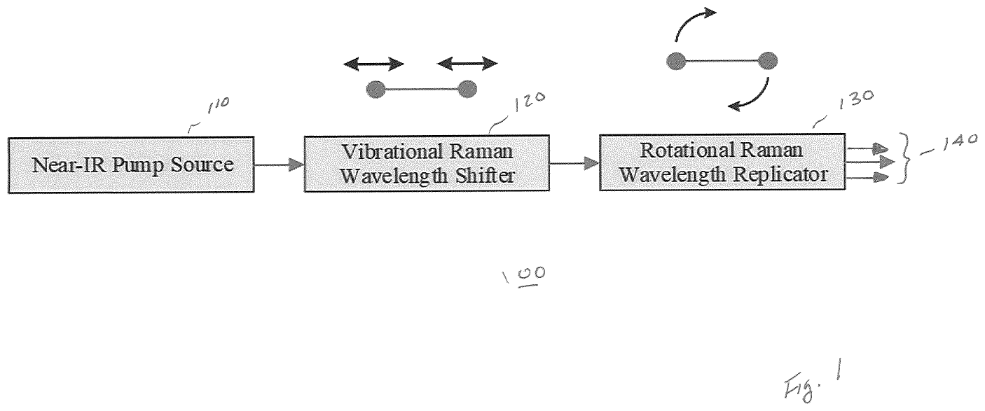

With reference to FIG. 1, a MWIR laser system 100 according to one embodiment or the present invention emits at multiple wavelengths spanning the mid-IR transmission bands with tunability not to coincide with absorption lines within the bands. The present invention uses optical fiber-based pump sources 110 and Raman fiber wavelength shifting amplifiers to create a single output aperture that comprise multiple spectral lines within each required MWIR sub-band.

A high-power, near-infrared laser (near-IR) source 110 is introduced into a resonator 120 where vibrational transitions in a molecular gas shift the wavelength into the mid-IR. The output of the wavelength shifter is launched into a second resonator 130 where rotational excitations of gaseous molecules to replicate the laser signal, creating a collection of laser lines 140 that span a mid-IR transmission window. Vibrational Raman amplification is, in this implementation, more efficient than rotational Raman amplification because it requires the transfer of less energy. In vibrational Raman amplification, the energy is transferred from one photon to another photon. This transfer of energy causes the photons to change their wavelength. In rotational Raman amplification, the energy is transferred from one molecule to another molecule. This transfer of energy causes the molecules to change their wavelength but at the cost of more energy. In the present example, separate 50-W units are configured for spectral coverage of each of the two mid-IR bands and combined to meet requirements for total mid-IR power. The baseline for this approach employs Continuous Wave (CW) pump sources and produces CW output. In one version of the present invention, one or more MWIR systems are constructed with optical fiber for compactness and to increase interaction lengths in the wavelength shifters/replicators. Fiber modal properties are tailored to produce output beams with an M² of 1.5.

Vibrational Raman amplification and rotational Raman amplification are both processes that can amplify light through scattering, but they involve different types of molecular motions and have different characteristics.

In vibrational Raman amplification, a photon interacts with a molecule and excites its vibrational mode, which causes the molecule to temporarily store the energy of the photon. This stored energy is then re-emitted as a new photon with a lower frequency than the original photon. The emitted photon has a frequency that is shifted by an amount corresponding to the vibrational frequency of the molecule, which is characteristic of the molecule and can be used for identification and analysis. Vibrational Raman amplification is a relatively weak effect and requires intense laser light to achieve significant amplification.

Rotational Raman amplification, on the other hand, involves the interaction of light with the rotational motion of a molecule. In this process, a photon is scattered by a molecule and transfers some of its energy to the molecule, which causes the molecule to rotate. This interaction causes the light to be amplified or scattered, depending on the frequency of the incident light and the rotational properties of the gas molecules. The scattered photon has a frequency that is shifted by an amount corresponding to the rotational energy of the molecule. Unlike vibrational Raman amplification, rotational Raman amplification does not require a laser source and can occur with ordinary light sources such as sunlight. However, it is also a weaker effect than many other types of light scattering.

In more detail, when light passes through a gas, it may interact with the gas molecules through a process known as the Raman effect. This effect occurs when the energy of the photons in the light is absorbed by the gas molecules, causing them to vibrate and rotate. As the gas molecules vibrate and rotate, they emit photons at different frequencies, which can be either lower or higher than the frequency of the incident light.

Rotational Raman amplification specifically refers to the amplification of the lower-frequency photons that are emitted by the gas molecules during this process. This occurs because the gas molecules have a preferred orientation in their rotational motion, and the incident light can only interact with molecules that are oriented in a particular way. As a result, the scattered light is preferentially emitted in a particular direction, and this directional emission leads to amplification of the lower-frequency photons.

The main difference between vibrational Raman amplification and rotational Raman amplification is the type of molecular motion that is involved. Vibrational Raman amplification involves the excitation of vibrational modes, while rotational Raman amplification involves the excitation of rotational modes. Vibrational Raman amplification is a relatively weak effect that requires intense laser light, while rotational Raman amplification can occur with ordinary light sources but is also a weaker effect.

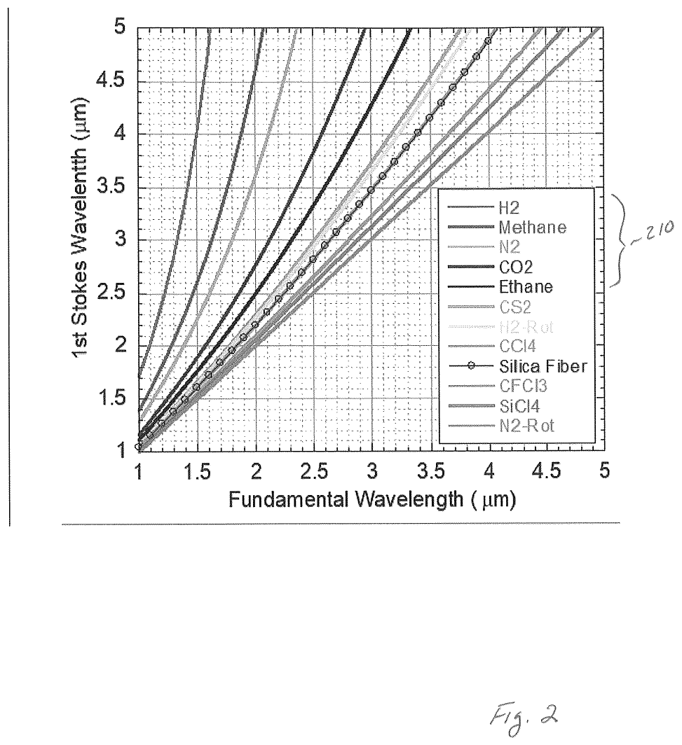

One aspect of the present invention is the selection of combinations of Raman media to efficiently shift the power from a high-power IR pump laser into several laser lines in the mid-IR. Location of Stokes-shifted laser lines for selected transitions in various Raman active media is shown in FIG. 2. Of particular interest are gaseous media 210, which have narrow Raman line widths, high gain coefficients, and can be used in hollow-core optical fibers to provide very long interaction lengths. One of reasonable skill in the relevant art will appreciate that one of the most efficient combinations of Raman media to shift the power from a high-power IR pump laser into several laser lines in the mid-IR is one or more combinations of CO2, N2, and He gas. These combinations are especially useful for applications that require high powers in multiple lines. CO2 is effective in shifting the power from the pump laser into the strongest mid-IR lines, while N2 and He can be used to shift the power into weaker lines in the mid-IR region. The advantage of this combination is that it can efficiently shift the power from the pump laser into multiple laser lines with high efficiency. Additionally, it can be used to generate multiple lines with different powers, which can be useful for applications that require specific power levels in different laser lines.

Recall, Raman scattering is a nonlinear optical process that can be used to shift the frequency of a laser beam to longer or shorter wavelengths. The present invention exploits this process to efficiently convert the power of a high-power infrared (IR) pump laser into several laser lines in the mid-IR region.

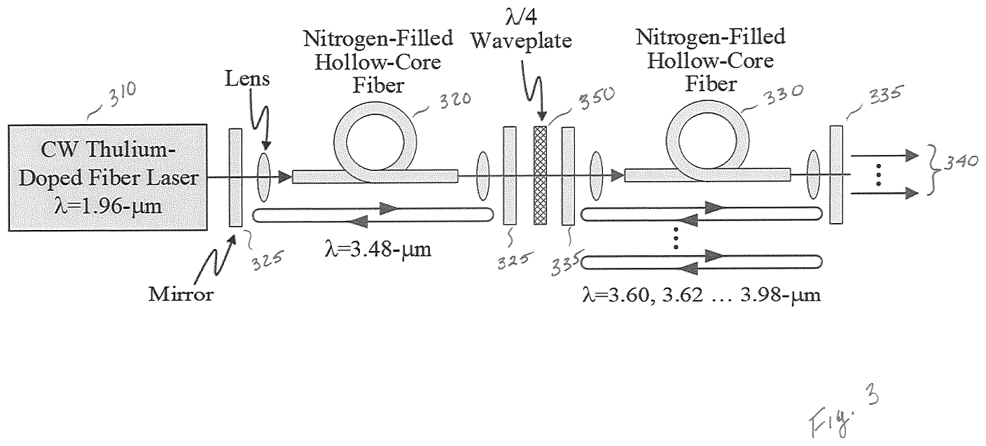

Another aspect of the present invention is lower MWIR band implementation. These implementations of the basic architecture produce multiple laser lines in the lower mid-wave IR band between 3.5 and 4.1 inn. One implementation of the Raman shifting architecture to produce laser lines in the lower mid-infrared band of the present invention is shown in FIG. 3.

In this version of the present invention, Thulium-doped fiber lasers 310 with CW output power exceeding a kilowatt are used as a pump source for a nitrogen-filled hollow-core fiber 320. The fiber is placed between mirrors 325 with reflectance, in this embodiment, at a maximum of 3.48 μm to resonate (using vibrational transitions) and enhance the Stokes shifted light. The output of the first resonator is introduced into a second resonator 330 where Raman shifting by way of rotational transitions in nitrogen gas, and corresponding mirrors 335, is used to convert the 3.48 μm signal into multiple lines 340 in the lower mid-IR band. The first resonator employs narrow band mirrors on both sides that resonate only a single Raman shifted line. The second resonator uses broadband mirrors that resonate multiple Raman shifted lines in a cascade. A quarter wave plate 350 converts linearly polarized light to circularly polarized light for selective interaction with rotational Raman modes. The quarter-wave plate 350 converts linearly polarized light into circularly polarized light by introducing a phase shift of one quarter of a wavelength between two perpendicular components of the light. When linearly polarized light passes through a quarter-wave plate, it is split into two perpendicular components, one that experiences a phase shift of 90 degrees and another that does not experience any phase shift. The two components then recombine, but because of the phase shift, they are now out of phase with each other by 90 degrees. This results in circularly polarized light. Efficiency factors of 40%, 50%, and 50% have been achieved for the pump, first resonator, and second resonator, respectively, producing an overall wall-plug efficiency of 10%.

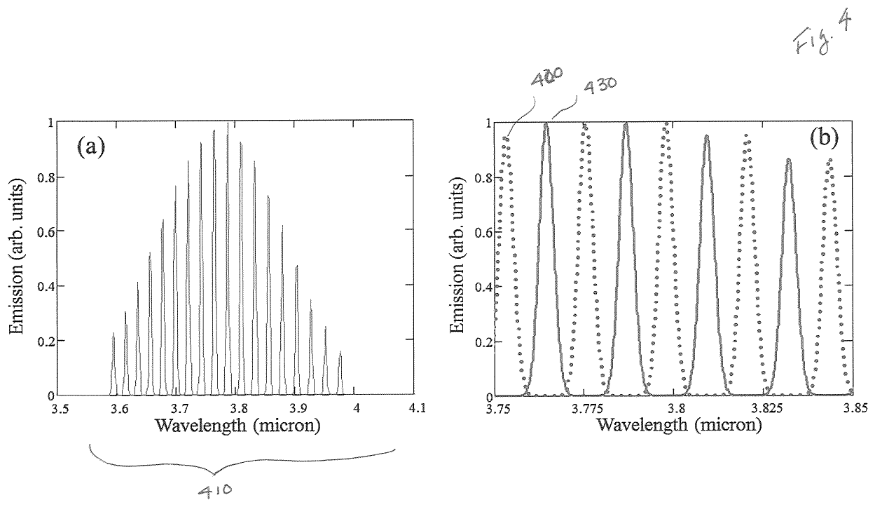

FIG. 4 presents the spectral output for the implementation shown in FIG. 3. The band coverage 410 (shown in the left side of FIG. 4) is limited by the number of rotational transitions in nitrogen gas that have large, stimulated Raman gain. This instance of the present invention shows an expansion of wavelength coverage to the full 3.5 to 4.1 μm band. The right side of FIG. 4 further shows that relatively small changes in the pump wavelength (i.e., the dashed lines 420 versus the solid lines 430) can be used to tune the precise positions of the laser lines 420. This flexibility is important for design of a system with maximum atmospheric transmission. Temperature tuning and pressure broadening are considered with respect to performance.

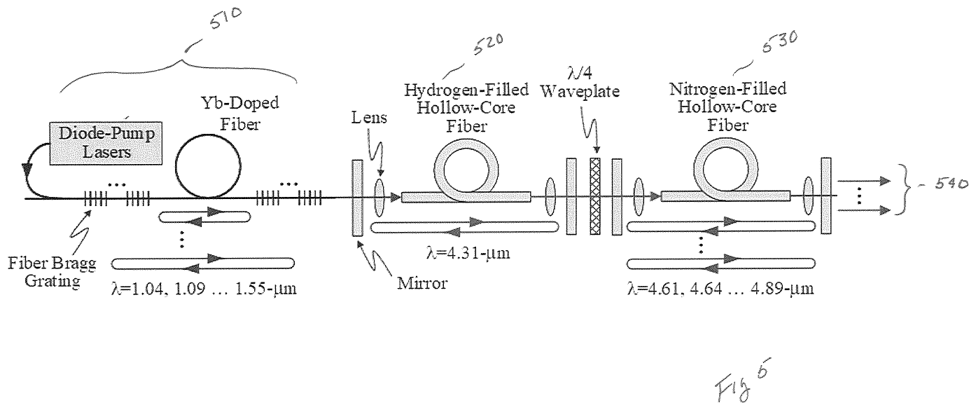

Various implementations of the present invention's basic architecture produce multiple laser lines, for example, in the upper mid-IR band between 4.6 and 4.9 inn. Yet another implementation of the present invention is shown in FIG. 5. In this instance the combination of laser pump source and first Raman resonator are changed to produce outputs at longer wavelengths. A pump source 510 with a wavelength of 1.55 μm is created by starting with emission at 1.04 μm in an Ytterbium-doped fiber laser and cascading the signal to 1.55 μm through a series of Raman Stokes shifts. The use of erbium-doped fiber is an alternative 1.55 μm pump source.

In this case, the output of the fiber laser 510 is launched into a hollow-core fiber filled with hydrogen gas 520, which has a larger Raman shift and produces a signal at a longer 4.31 μm wavelength, despite the shorter pump wavelength. The shifted light is then launched into the second resonator 530 to produce multiple laser lines 540 in the upper mid-IR band. As for the lower band source, efficiency factors of at least 40%, 50%, and 50% for the pump, first resonator, and second resonator can be achieved, respectively, producing an overall wall-plug efficiency of 10% or more.

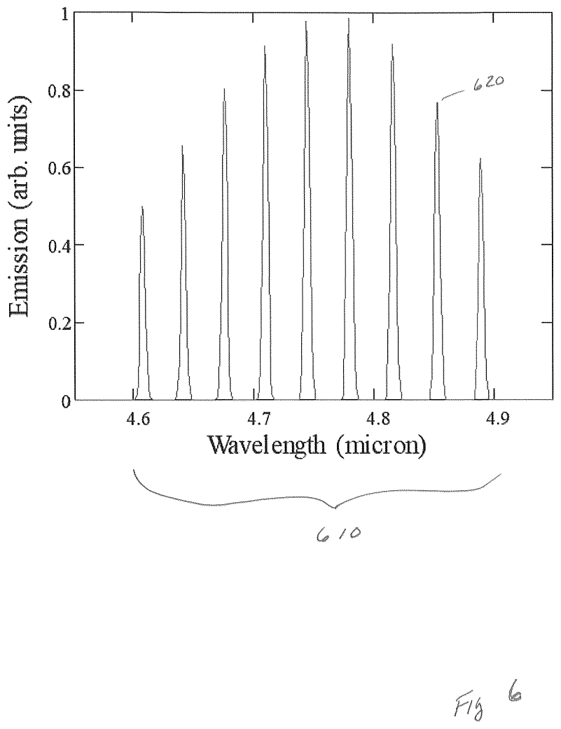

FIG. 6 presents output results of the implementation shown in FIG. 5. The narrower upper band 610 is fully spanned by the signals 620, which have slightly larger separations at these wavelengths. A similar approach to the fine control of wavelength shifting would be as discussed in the previous lower band discussions.

The present invention uses a single beam line for each MWIR sub-band with sequential cascaded Raman spectral generators rather than combine many spectrally separate sources into a common aperture. This approach directly addresses manufacturing and life-cycle costs along with the ability to add spectral components (providing increased spectral power density) and power scaling of the overall system by increased pump power in future versions. Importantly, the architecture of the present invention is based upon CW kW-class diode-pumped fiber laser technologies for the Raman pump sources and utilizes the well understood and demonstrated Raman wavelength cascade processes in gas.

Another version of the present invention uses first rotational excitations in the first resonator creating a collection of laser lines from an initial input followed by a second resonator using vibrational transitions in a molecular gas shift shifting the wavelength of each laser line into the mid-IR. This embodies the versatility of a multiple resonator configuration to produce a plurality of laser lines in the mid-IR region.

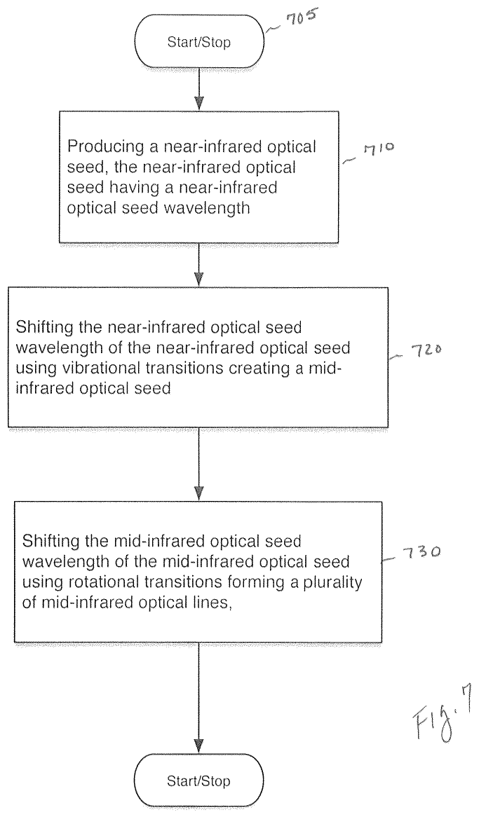

FIG. 7 presents a flow chart for one methodology to form a plurality of Mid-Wave Infrared (MWIR) optical lines, according to one embodiment of the present invention. The process begins 705 by producing 710 a near-infrared optical seed by an optical source. The near-infrared optical seed has a near-infrared optical seed wavelength that may vary depending on the desired output. In one version of the present the near-infrared optical seed is generated from an optical fiber-based pump while in another version of the invention a continuous wave pump source is used. For example, one implementation of the invention can use Thulium-doped fiber lasers with CW output power exceeding a kilowatt. Similarly, a pump source can be used by starting with emission in an Ytterbium-doped fiber laser and cascading the signal through a series of Raman Stokes shifts to produce the desired seed.

The process thereafter shifts 720, by a first Raman resonator, the near-infrared optical seed wavelength of the near-infrared optical seed using vibrational transitions. This creates a mid-infrared optical seed, wherein the mid-infrared optical seed has a mid-infrared optical seed wavelength greater than the near-infrared optical seed wavelength. The first Raman resonator reflects light between two semitransparent mirrors and lens systems until the light reaches a desired power and wavelength. At that point the light is directed through a quarter wave plate that converts the mid-infrared optical seed from linearly polarized light to circularly polarized light.

The now circularly polarized light, the mid-infrared optical seed having a mid-infrared optical seed wavelength) is again shifted 730 by a second Raman resonator, this time using rotational transitions. This shift and application of rotational transitions forms a plurality of mid-infrared optical lines, wherein each of the mid-infrared optical lines has a mid-infrared optical line wavelength greater than the mid-infrared optical seed wavelength.

Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention. Particularly, it is recognized that the teachings of the foregoing disclosure will suggest other modifications to those persons skilled in the relevant art. Such modifications may involve other features that are already known per se, and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. A Mid-Wave Infrared (MWIR) laser system, comprising:
an optical source producing a near-infrared optical seed, the near-infrared optical seed having a near-infrared optical seed wavelength;
a first Raman resonator optically coupled to the optical source and configured to accept the near-infrared optical seed whereby the first Raman resonator shifts the near-infrared optical seed wavelength of the near-infrared optical seed using vibrational transitions creating a mid-infrared optical seed, the mid-infrared optical seed having a mid-infrared optical seed wavelength greater than the near-infrared optical seed wavelength; and
a second Raman resonator optically coupled to the first Raman resonator optically and configured to accept the mid-infrared optical seed whereby the a second Raman resonator shifts the mid-infrared optical seed wavelength of the mid-infrared optical seed using rotational transitions forming a plurality of mid-infrared optical lines, each of the mid-infrared optical lines having a mid-infrared optical line wavelength greater than the mid-infrared optical seed wavelength.

2. The Mid-Wave Infrared (MWIR) laser system of claim 1, wherein a mid-infrared optical seed wavelength of the mid-infrared optical seed is less than or equal to 3.48 μm.

3. The Mid-Wave Infrared (MWIR) laser system of claim 2, wherein the plurality of mid-infrared optical lines possesses an optical line wavelength between 3.5 and 4.1 μm.

4. The Mid-Wave Infrared (MWIR) laser system of claim 1, wherein the first Raman resonator is a gas filled hollow-core fiber.

5. The Mid-Wave Infrared (MWIR) laser system of claim 1, wherein the first Raman resonator is a nitrogen filled hollow-core fiber.

6. The Mid-Wave Infrared (MWIR) laser system of claim 1, wherein the second Raman resonator is a gas filled hollow-core fiber.

7. The Mid-Wave Infrared (MWIR) laser system of claim 1, wherein the second Raman resonator is a nitrogen filled hollow-core fiber.

8. The Mid-Wave Infrared (MWIR) laser system of claim 1, wherein the mid-infrared optical seed is linearly polarized light.

9. The Mid-Wave Infrared (MWIR) laser system of claim 8, further comprising a quarter wave plate interposed between the first Raman resonator and the second Raman resonator configured to convert the mid-infrared optical seed from linearly polarized light to circularly polarized light.

10. The Mid-Wave Infrared (MWIR) laser system of claim 1, wherein the optical source is a supercontinuum source.

11. The Mid-Wave Infrared (MWIR) laser system of claim 1, wherein the optical source is a continuous wave pump source.

12. The Mid-Wave Infrared (MWIR) laser system of claim 1, wherein the optical source is a Thulium-doped fiber laser.

13. The Mid-Wave Infrared (MWIR) laser system of claim 12, wherein the Thulium-doped fiber laser output power exceeds one kilowatt.

14. The Mid-Wave Infrared (MWIR) laser system of claim 1, wherein the optical source is a cascading Ytterbium-doped fiber laser.

15. The Mid-Wave Infrared (MWIR) laser system of claim 14, wherein the cascading Ytterbium-doped fiber laser accepts a 1.04 μm emission and cascades the signal through a series of Raman Stokes shifts producing a 1.55 μm pump source.

16. The Mid-Wave Infrared (MWIR) laser system of claim 15, wherein a mid-infrared optical seed wavelength of the mid-infrared optical seed is less than or equal to 4.31 μm.

17. The Mid-Wave Infrared (MWIR) laser system of claim 16, wherein the plurality of mid-infrared optical lines has optical line wavelengths between 4.61 and 4.89 μm.

18. The Mid-Wave Infrared (MWIR) laser system of claim 1, wherein the first Raman resonator includes narrow band mirrors on both sides that resonate a single Raman shifted line.

19. The Mid-Wave Infrared (MWIR) laser system of claim 1, wherein the second Raman resonator includes broadband mirrors that resonate multiple Raman shifted lines in a cascade.

20. A method for forming Mid-Wave Infrared (MWIR) optical lines, the method comprising:
producing, by an optical source, a near-infrared optical seed, the near-infrared optical seed having a near-infrared optical seed wavelength;
shifting, by a first Raman resonator, the near-infrared optical seed wavelength of the near-infrared optical seed using vibrational transitions creating a mid-infrared optical seed, wherein the mid-infrared optical seed has a mid-infrared optical seed wavelength greater than the near-infrared optical seed wavelength; and
shifting, by a second resonator Raman resonator, the mid-infrared optical seed wavelength of the mid-infrared optical seed using rotational transitions forming a plurality of mid-infrared optical lines, wherein each of the mid-infrared optical lines has a mid-infrared optical line wavelength greater than the mid-infrared optical seed wavelength.

21. The method for forming Mid-Wave Infrared (MWIR) optical lines according to claim 20, further comprising converting, by a quarter wave plate interposed between the first Raman resonator and the second Raman resonator, the mid-infrared optical seed from linearly polarized light to circularly polarized light.
